(19) United States
(12) Patent Application Publication
(10) Pub. No.: US 2016/0171422 A1
(43) Pub. Date: Jun. 16, 2016

(54) Method and System for Generating Staffing Requirements for Deferred Work in a Contact Center Environment

(71) Applicant: Interactive Intelligence Group, Inc., Indianapolis, IN (US)

(72) Inventors: Bayu Aji Wicaksono, Laurel, MD (US); FeiFei Huang, Seattle, WA (US); Amit Garg, Annapolis, MD (US)

(21) Appl. No.: 14/829,796

(22) Filed: Aug. 19, 2015

Related U.S. Application Data
(60) Provisional application No. 62/089,988, filed on Dec. 10, 2014.

(51) Int. Cl. G06Q 10/06

(52) U.S. Cl. CPC G06Q 10/063118; G06Q 10/06375

(57) ABSTRACT

A system and method are presented for generating staffing requirements for deferred work in a contact center environment. Dynamic backlog control is utilized to account for backlog from deferred work in order to produce steady staffing levels throughout planning periods. Optimal backlog is determined to be passed from one interval to the next, by systematically evaluating a number of points, in order to optimize the number of staff and staff time in the contact center environment in order to achieve performance levels.

### CROSS-REFERENCE TO RELATED APPLICATIONS

This application claims priority to U.S. provisional application 62/089,988 filed Dec. 10, 2014, entitled “Method and System for Generating Staffing Requirements for Deferred Work in a Contact Center Environment”, the contents of which are incorporated herein.

### BACKGROUND

The present invention generally relates to telecommunications systems and methods, as well as contact center environments. More particularly, the present invention pertains to staffing requirements in the contact center environments.

### SUMMARY

A system and method are presented for generating staffing requirements for deferred work in a contact center environment. Dynamic backlog control is utilized to account for backlog from deferred work in order to produce steady staffing levels throughout planning periods. Optimal backlog is determined to be passed from one interval to the next, by systematically evaluating a number of points, in order to optimize the number of staff and staff time in the contact center environment to achieve performance levels.

In one embodiment, a method is presented for generating staffing requirements, accounting for deferred work, in a contact center environment planning system, wherein the contact center environment planning system comprises a network configuration optimization system, the method comprising the steps of: performing, by the network configuration optimization system, an initial setup of parameters at a period of a planning scenario; invoking, by the network configuration optimization system, a search to determine an optimum number of staff for the periods of a planning scenario; and running, by the network configuration optimization system, additional planning scenarios at other periods of a planning scenario.

In another embodiment, a method is presented for generating staffing requirements, accounting for deferred work, in a contact center environment planning system, wherein the contact center environment planning system comprises a network configuration optimization system, the method comprising the steps of: performing, by the network configuration optimization system, an initial setup of parameters at a selected set of periods of a planning scenario, wherein the selected set of periods are not concurrent; invoking, by the network configuration optimization system, a search to determine an optimum number of staff for the selected set of periods of a planning scenario; and running, by the network configuration optimization system, additional planning scenarios at other periods of a planning scenario.

### BRIEF DESCRIPTION OF THE DRAWINGS

FIG. 1 is a diagram illustrating an embodiment of a typical telecommunications network within a contact center.

FIG. 2 is a diagram illustrating an embodiment of a modified telecommunications network within a contact center.

FIG. 3 is a flowchart illustrating an embodiment of a process for determining staffing requirement generation.

FIG. 4 a flowchart illustrating an embodiment of a process for performing the main search.

FIG. 5 is a flowchart illustrating an embodiment of a process for determining an adjustable goal.

FIG. 6 is a flowchart illustrating an embodiment of a process for evaluating dynamic backlog control.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

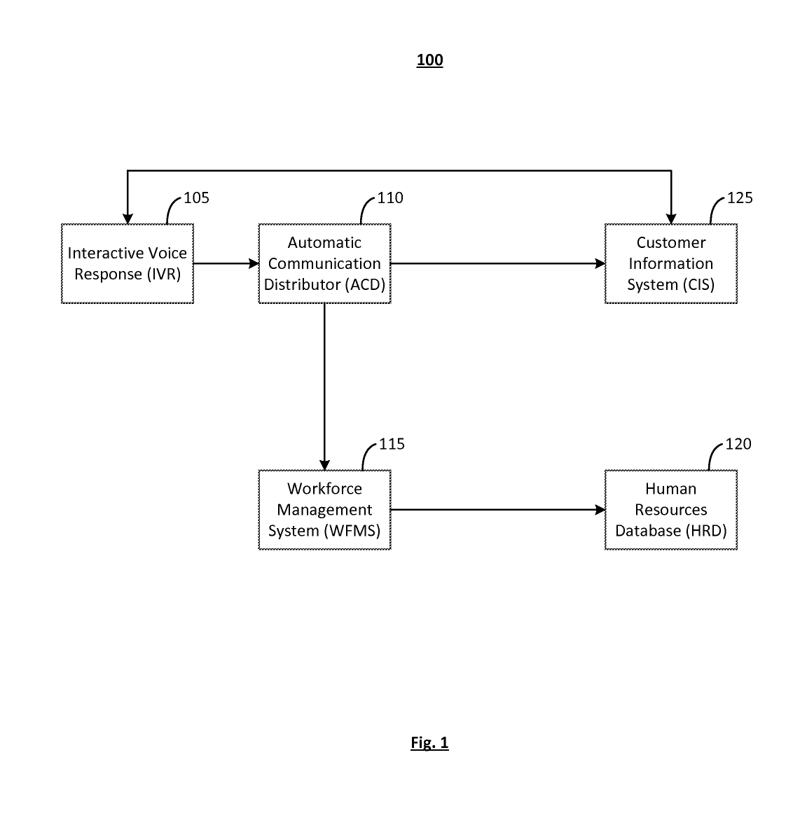

FIG. 1 is a diagram illustrating an embodiment of a typical telecommunications network within a contact center, indicated generally at 100. A typical telecommunications network within a contact center 100 known in the prior art includes an Interactive Voice Response system (IVR) 105, an Automatic Communication Distributor (ACD) 110, a Workforce Management System (WFMS) 115, a Human Resources Database (HRD) 120, and a Customer Information System (CIS) 125. The telecommunications network of some contact centers may vary from the telecommunications network 100 in that the data systems in the network may be combined and the infrastructure configuration may differ. Nevertheless, the function of the systems and the type of data residing in these other telecommunications networks is consistent with that residing in the telecommunications network 100, and therefore, the following discussion will also apply to these other networks.

The IVR 105 comprises an automated voice response system that is activated when a communication, such as a call, is received by the contact center. The IVR 105 provides a variety of options to a caller that are used to determine the purpose of the call and that are ultimately used to route the call to the appropriate resource. The IVR 105 also may obtain the caller's account or customer number (if one is available) and accesses the CIS 125 to determine how this caller should be treated based on the caller's account information (e.g., exposed to a tailored advertisement or, if a particularly good customer, routed to the best agent). The IVR sends the time called, the account number, the options chosen, and other data to the ACD 110 and to the CIS 125.

The ACD 110 automatically distributes the incoming communications, such as calls, to available resources within the telecommunications network 100 (e.g., agent telecommunication systems which may comprise phone agents and phone lines). In an embodiment, the network 100 may operate as part of a contact center at one or more physical locations which may be remote from each other. Agent telecommunication systems, or workstations, may be coupled to the network 100. Although not shown to preserve clarity, the workstations each include a workstation computer coupled to a display. Digital telephones are each associated with a different workstation. Each digital telephone may be connected to the network 100 through a network interface. In a further form, the connection to the network may be made first to the digital phone, then from the digital phone to the workstation computer by way of a pass-through connection on the digital phone or vice versa. Alternatively, two connections from the network can be made, one to the digital phone and one to the workstation computer. Additionally, in yet another form, digital telephones may be integrated into the agent computer and/or implemented in software. Each agent workstation may include one or more operator input devices, such as a keyboard, mouse, etc. Also, besides the display, one or more other output devices may be included such as loudspeaker(s) and/or a printer.

The ACD 110 also sends call interval data to the WFMS 115 (i.e., call data summarized by a particular unit of time, such as by half-hour). The call interval data includes, for each interval, call volume (e.g., 400 calls), number of phone agents available, number of phone agents occupied by handling calls, average handle time (e.g., 2 minutes), number of abandons, the mean time to abandon, the average wait time, service level (e.g. of the proportion of calls answered in less than or equal to a specified number of seconds, such as 80% within 20 seconds, for example), and the average call duration. The ACD 110 also sends call-by-call data to the CIS 125. The call-by-call data includes the wait time of the call, the employee that handled the call, the handle time of the call, the time to abandon (if applicable), the amount of after call work or casework required, and details on the customer order, purchases, or other activity (if applicable).

WFMS 115 forecasts contact volumes and handle times and develops employee schedules in such a manner that resources are available to answer or process the incoming flow of contacts. The WFMS 115 uses generic forecasting techniques such as moving averages or autoregressive integrated moving average (ARIMA) models to predict, for any future day, the number of contacts the center can expect. The WFMS 115 then determines the phone agent staffing levels by time of day that will result in the center's meeting an overall service standard goal for the forecasted number of contacts. Shift optimization determinations are then used to determine the shifts that will best cover the estimated staffing requirements. The WFMS 115 also provides processes to monitor phone agent productivity and to allow phone agents to select and manage their weekly work-shifts. The WFMS 115 sends schedules, shift swaps, schedule adherence, and hours worked data to the HRD 120.

The HRD 120 tracks payroll information and the number of hours worked by phone agents. Specifically, the HRD 120 tracks schedules, shifts, schedule adherence, hours worked, vacation accrued, salary information, and hiring costs. The HRD 120 receives the forecast from the WFMS 115 and uses it to determine when to hire new employees and when to schedule training classes.

The CIS 125 incorporates customer account information including customer segmentation and customer value and gathers call-by-call data from the ACD 110 into a common computer database. The CIS 125 delivers account information such as customer value to the IVR 105 in order to assign an appropriate treatment for a given caller (e.g., if the customer is highly valued, route the call to the best agent).

The typical telecommunications network within a contact center 100 is not able to generate rapid analysis and plans for staffing, budgeting, call handling, and service quality goal setting. Nothing in the typical telecommunications network 100 allows the management of a contact center to quickly and accurately know the effects on contact center performance of changes in staff, budgets, call handling, and service goals. The analytic techniques used in a typical telecommunications network within a contact center 100 are not able to perform these analyses because they are either too simplistic for these types of scenarios (e.g., Erlang C) or too slow for rapid “what-if” analysis (e.g., discrete-event simulation).

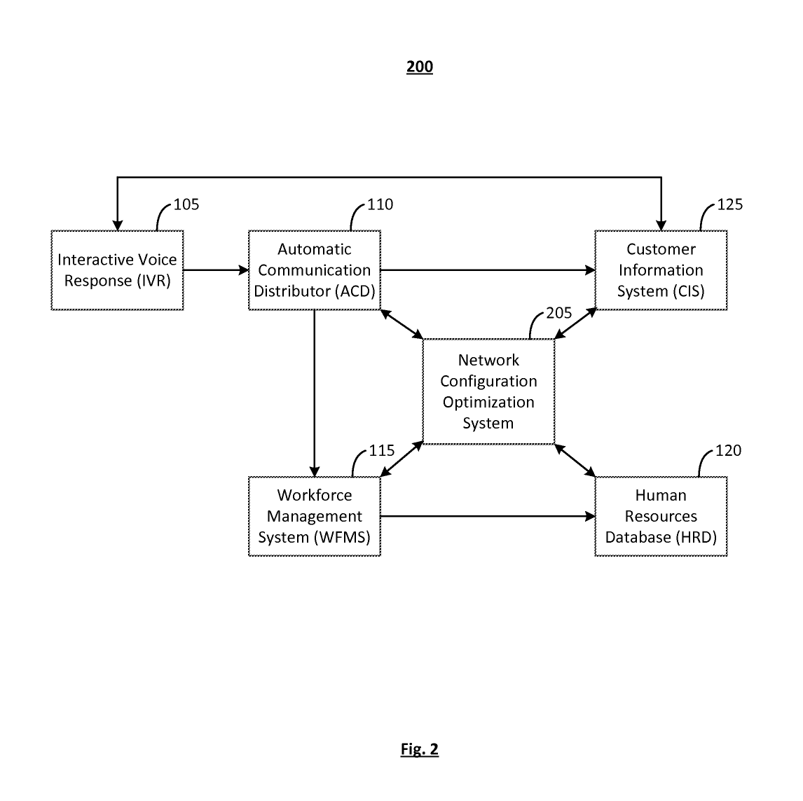

Referring to FIG. 2, one implementation of a telecommunications network within a contact center 200 is shown that includes the typical performance monitoring and analysis components associated with the telecommunications network 100 with an additional interconnected Network Configuration Optimization System 205. The Network Configuration Optimization System 205 exchanges performance data and performance history data with the performance monitoring systems in the telecommunications network 100 and produces rapid analyses and plans for staffing, budgeting, call handling, and service quality goal setting. While the exemplary implementation of the telecommunications network is within a contact center system, it should be understood that the telecommunications network may include any type of system in which work is handled by a workforce having a finite number of resources. Such systems may include, but not be limited to, operations that handle and process incoming e-mail messages and inquiries, facsimile messages, insurance claims, and financial instruments including checks and coupons.

The Network Configuration Optimization System 205 receives performance information directly from all of the performance monitoring systems in the telecommunications network 100 with the exception of the IVR 105. Specifically, the ACD 110 provides the Network Configuration Optimization System 205 with regular feeds of call interval data. The Network Configuration Optimization System 205 may, alternatively, receive call interval data from the WFMS 115 rather than the ACD 110. The WFMS 115 provides the Network Configuration Optimization System 205 with periodic feeds of the latest contact volume forecast including the contact volume (e.g., call volume) and handle time forecast. The WFMS 115 also may provide the Network Configuration Optimization System 205 with a schedule adherence forecast. The HRD 120 provides the Network Configuration Optimization System 205 with agent salary information and hiring costs that may be accessed by the system 205 as needed. Finally, the CIS 125 provides the Network Configuration Optimization System 205 with customer segmentation, customer value, and call-by-call data.

The Network Configuration Optimization System 205 also sends information back to all of the performance monitoring systems in the telecommunications network 200. Specifically, the Network Configuration Optimization System 205 sends the call routing plan (e.g. how best to route different types of calls) back to the analysts who manage the ACD 110. The Network Configuration Optimization System 205 provides the WFMS 115 with the staffing plan. The staffing plan may include the hiring plan; the number of vacation, sick, and training days; the number of agents transferred between management units; and the skills of the agents (e.g. able to speak Spanish or that can handle complex requests well). The WFMS 115 incorporates all of this information into the staffing schedule. The Network Configuration Optimization System 205 also provides the staffing plan to the HRD 120 and its analysts along with a budget estimate corresponding to that staffing plan.

Finally, the Network Configuration Optimization System 205 provides a series of customer reports to the CIS 125 and its analysts that show the experience that each customer segment has had with the contact center in the past and, given the current staffing plan, the experience each customer segment is expected to have in the future. The reports may contain the following for each customer segment: the service level, the call wait time, the probability of abandon, the mean time to abandon, the cost of abandon, the average handle time, the customer value, the distribution of call purpose, and a customer satisfaction measure.

In a typical WFMS 115 that performs the process of scheduling agents in telecommunications networks within contact centers, for example, simulation (or mathematical/probabilistic) models are created to optimize the service performance goals for the lowest cost possible. Models are created for all possible contact/interaction types, such as customer service chats, sales calls, support e-mails, etc., in order to optimize the service performance goals for the lowest cost possible. Typical service performance goals may be: 80% of calls handled within 20 seconds or 100% of e-mails handled within 24 hours. In order to achieve these goals, for example, the WFMS 115 has to predict the interaction load and schedule the agents necessary while conforming to the customers' agent constraints. The accuracy may then be judged by whether or not service performance goals are met and by how many agent hours it schedules to achieve that.

Different types of work may be accounted for, such as immediate and deferred. Immediate work, such as inbound call or chat, may be treated very differently than deferred work, such as email or back-office work. In the case of immediate work, performance measurement is straight-forward and can be easily aggregated to a certain reporting period or interval. This is because of the nature of the immediate work where contacts that are not handled are abandoned (i.e., do not stay in the system). However, in the case of deferred work, this work is not abandoned. Performance measurement becomes much more difficult. Not only is the service level agreement (SLA) threshold significantly longer for deferred work than for an inbound call, but service level rules cannot be applied to e-mail planning because of backlogs (i.e., every e-mail will eventually get handled).

As a result, staffing is more problematic when dealing with deferred work. Staffing to only a service level may achieve high service level in the first few periods, but the backlog will also begin to accumulate. As work is handled in a first-in-first-out (FIFO) fashion, the accumulating backlog can lead to lower service levels in later periods and/or excessively high staffing numbers. Even if steady volume is assumed, staffing to only service level can result in fluctuating staffing results. Fluctuating staffing results are not desirable in a contact center environment for several reasons, such as hiring constraints (e.g., not being able to hire fast enough) and business policies (e.g., agents can only work a certain number of overtime hours). Therefore, deferred work cannot be staffed just to service level, unlike immediate work, such as inbound calls or chats.

Dynamic backlog control may be used to address the staffing problem created by deferred work. The amount of backlog passed at the end of a period should depend on the volume of the next period(s). Backlog helps the next period's staff remain properly occupied, but not overwhelmed, in order to achieve service level. Backlog at the end of each period may automatically be set to a certain percentage of the next period's volume, depending on factors such as service level threshold, staffing distribution, and volume distribution, to name a few non-limiting examples. In an embodiment, dynamic backlog control may be used to estimate the percentage of the next period's volume.

In another embodiment, the appropriate level of staff occupancy may be controlled. Staff and volume distributions can be such that, in order to achieve high service level goals, the staff becomes highly unoccupied (i.e., idle/inefficient). For example, a staffing distribution that is weighted heavily on the beginning of the week will be able to clear out backlog faster. However, when the level of backlog passed is low, these staff will be idle most of their time (i.e. low occupancy). The incoming volume of the period is evaluated along with the level of backlog from the previous period in order to automatically restrict the staff occupancy from resulting in a very low occupancy.

Steady, as opposed to fluctuating, staffing requirements levels are determined throughout the planning periods in a way that the service level goal is met or exceeded. Staffing requirement generation can thus perform in different types of scenarios, such as incoming volume fluctuations, large backlog, little/no backlog, very high or very low service level thresholds, significantly different/similar staffing and volume distributions, etc.

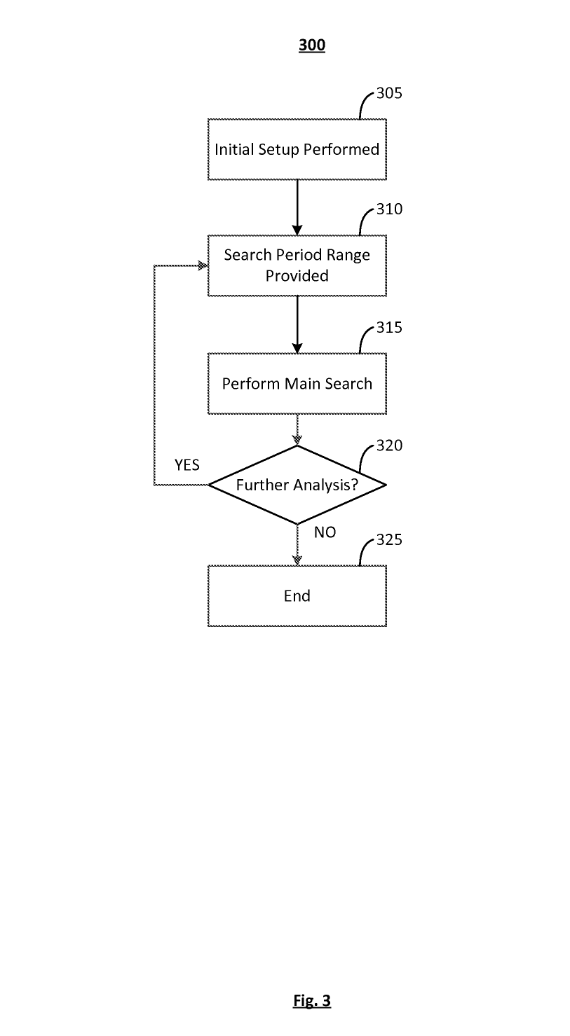

FIG. 3 is a flowchart illustrating an embodiment of a process for determining staffing requirement generation. This process may occur in the Network Configuration Optimization System 205. A number of inputs may be used in the process, such as the number of deferred work volume and average handle time, target performance metric, initial backlog, initial staff, and input distributions, to name a few non-limiting examples. The number of deferred work volume and average handle time may describe the forecasted workload to the system. A determination of the optimal staff may be made in order to achieve certain SLA thresholds given this workload forecast. The target performance metric may comprise the goal to be achieved, including service level (SL), wherein SL is expressed as a percentage, and the SLA threshold period. The initial backlog may describe the initial backlog coming into the system at the start of the planning scenario. The initial staff may describe the staff that currently exist in the contact center environment. The system automatically begins with the lowest staff value, which may be adjusted if there is a need to only determine staffing for selected periods. Input distributions may comprise a set of factors for each time interval of a collection of time periods that define the typical distribution of intervals input (i.e., volume, staff, average handle time (AHT)) throughout a time period (e.g., daily/weekly/monthly). Inputs are distributed to the same level at which the simulation model is calculated.

In operation 305, the initial setup is performed. In an embodiment, the initial setup comprises setting up the initial parameters of interest at the desired time interval level. In a non-limiting embodiment, the time interval level may be weekly. Validation of the input parameters occurs and the current daily staff and volume is summarized and aggregated to a time interval level. The steady-state-staff is determined and summarized at the daily level to determine the aggregated value at the weekly level. The steady-state-staff may be defined as the average desired time interval staff distributed uniformly to handle the average desired time interval volume that is also distributed uniformly. This result may then be used to calculate a safe backlog factor.

Additionally, the maximum and minimum backlog control factor are estimated. The backlog control factor may be defined as the target ratio of backlog divided by the steady-state volume. The steady-state volume may comprise the volume of work that the staff can handle if the staff and volume distributions were uniform. The backlog control factor may be estimated based on its low probability to overwhelm the system. The estimation of the backlog control factor may occur automatically by the system through evaluation of how well staff handles the incoming deferred work (e.g., a peak in volume distribution is followed, or overlapped, by a peak in staff distribution for service goals to be achievable).

The minimum backlog control factor may be used as the lower estimate for the final backlog factor, which is determined through the dynamic backlog control determination as described in further detail below. If one period passes too little backlog to the next period, the next period may not be well occupied in the beginning of the period, particularly when the incoming volume for the next period is larger than the previous period. The maximum backlog control factor may comprise a factor at which any higher backlog can result in missing service for some volume. If too much backlog is passed to the next period, the next period may have a hard time achieving a higher service level percentage, particularly with a low SLA threshold and very different staffing and volume distribution. It is important to maintain similar backlog levels from period to period.

The steady state backlog may be determined for each week, which is the minimum backlog control factor multiplied by the ratio of service level threshold divided by the period's length. Control is passed to operation 310 and process 300 continues.

In operation 310, the search period range is provided. In an embodiment, a user of the system may have previously determined which periods are desired for the planning scenario. For example, the user may want to know the planning for staffing of the contact center for the next year or for selected set(s) of periods. It may be that planning is only desired for the months of January and March, but not for February due to a hiring freeze. Selective sets of periods can be useful when optimal staff is needed in some periods, but staff cannot be adjusted in other periods based on preference or limitations (e.g., hiring freeze constraint, a changing overtime policy, etc.). Control is passed to operation 315 and process 300 continues.

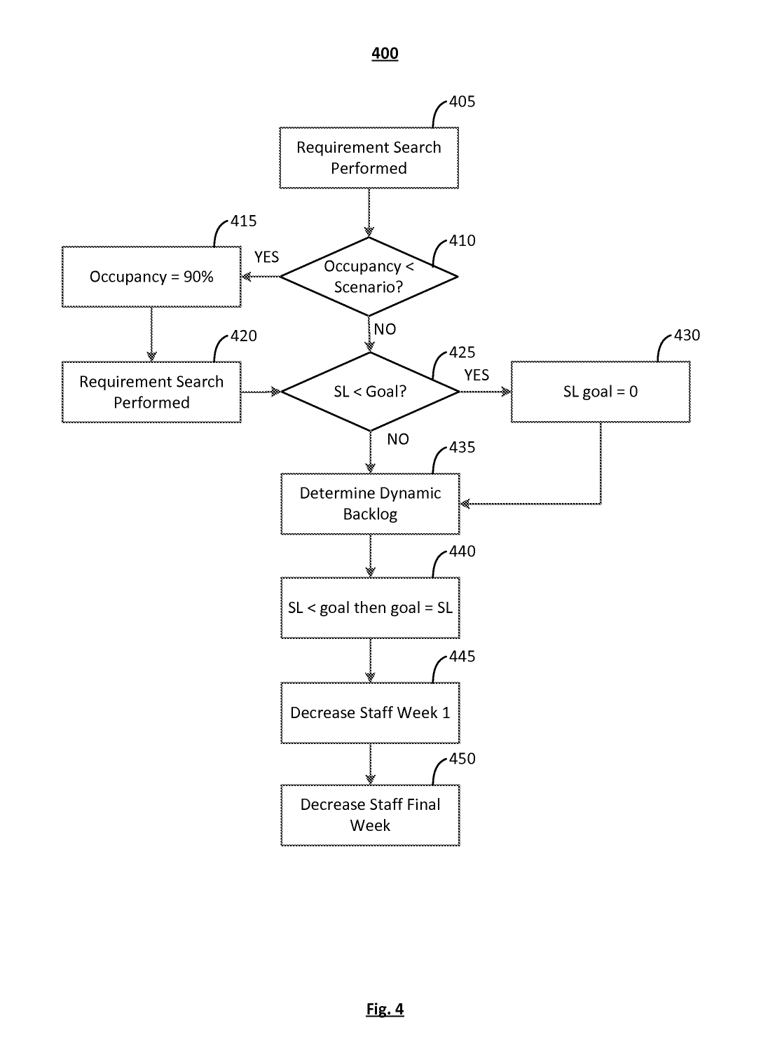

In operation 315, the main search is performed. For example, a requirement search is performed for the desired search period range in order to determine adjustable goals. Service level goals may be set by a customer which are practically impossible to achieve. Therefore, the service level goal may be automatically adjusted if the original goals are determined by the system to be impossible to achieve. High initial backlog may also lead to low occupancy for the first week of the planning scenario. As such, a stricter condition may be placed on the first period's staff occupancy and the service level goal is relaxed if needed for the first period. This process is described in greater detail in FIG. 4 below.

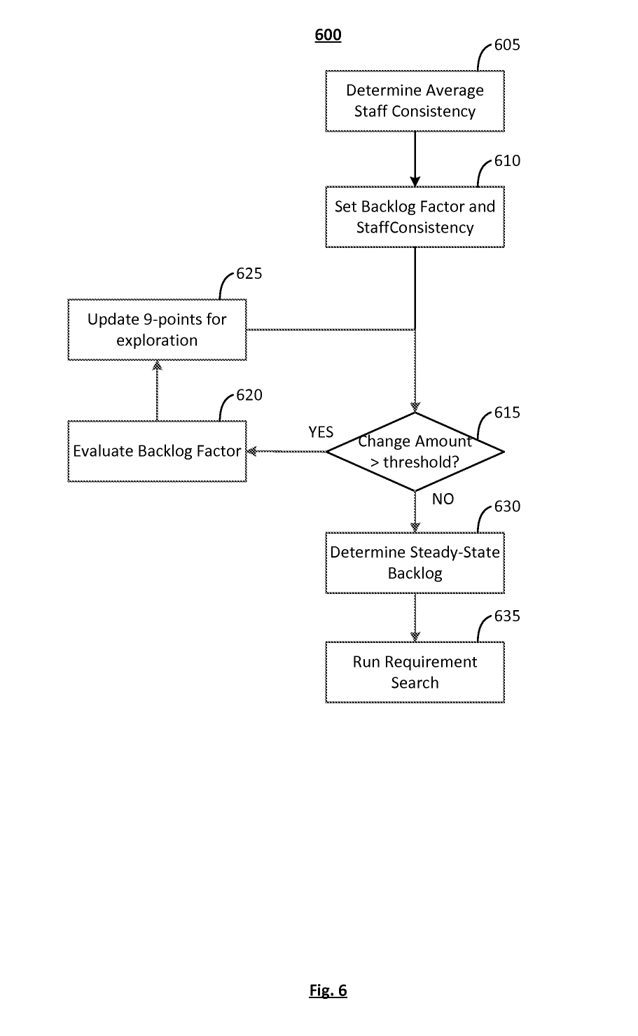

Dynamic backlog control may also be performed during the main search to identify the optimal backlog to be passed from one interval or period to the next. This process is discussed in further detail below in FIG. 6. Post-optimization procedures may be performed to reduce staff in selective periods without affecting other periods in order to ensure that the optimal staff are not in excess to achieve the same level of performance. Control is passed to operation 320 and process 300 continues.

In operation 320, it is determined if further analysis is needed. If it is determined that further analysis is needed, control is passed back to operation 310 and process 300 continues. If it is determined that further analysis is not needed, control is passed to operation 325 and the process 300 ends. Different “what-if” scenarios may be desired for different set(s) of period ranges for the main search. A user of the system may be curious to explore predictions of different scenarios by altering inputs to see other staffing requirements and outcomes, such as by altering the number of initial staff, removing periods with hiring freezes, etc.

FIG. 4 a flowchart illustrating an embodiment of a process for performing the main search. This process may occur in operation 315 of the process 300.

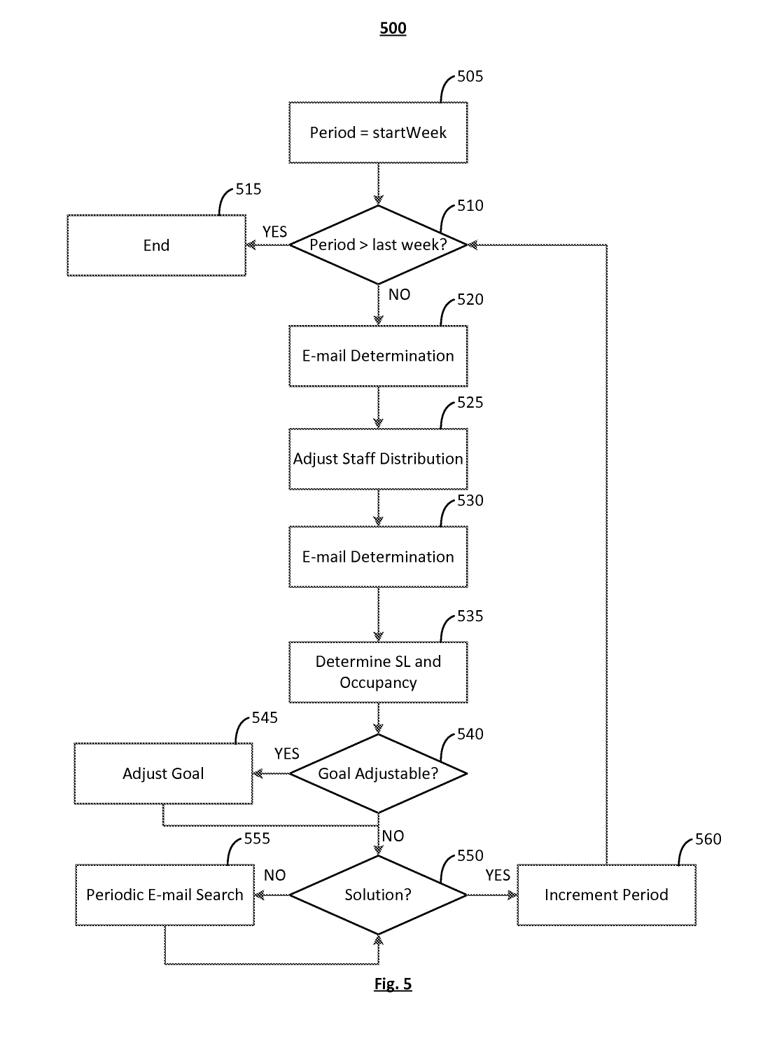

In operation 405, a requirement search is performed with an adjustable goal. The average occupancy is determined for all of the periods except for the first period. A time period may comprise an interval of time, such as a week. In a non-limiting example, the requirement search may be performed for all of the time periods or for some selective time periods in order to find staffing requirements given a service goal. This may be done whether or not the service level goal is adjustable. An un-adjustable setting may be used to test a particular backlog setting which may or may not be feasible. Adjustable settings may be used to ensure that service level goals are achievable. The requirement search process is further detailed below in FIG. 5. Control is passed to operation 410 and process 400 continues.

In operation 410, it is determined if the first period occupancy is less than the scenario (both 65% and 90% of average occupancy) of the other periods. If it is determined that the first period occupancy is less than both 65% and 90% of average occupancy of the other periods, control is passed to operation 415 and process 400 continues. If it is determined that the first period occupancy is not less than both 65% and 90% of average occupancy of the other periods, control is passed to operation 425 and process 400 continues.

In an embodiment, the occupancy comprises a measure of how busy or occupied staff are. Once an average occupancy is determined as a base, a range of 65-90% may be selected as a safe and effective usage of staff without compromising service. If occupancy of the first period is above 90%, then the first period's occupancy level may be assumed to be “similar” to other periods, even if the occupancy level of all periods is low. Occupancy of 65% of the baseline (i.e., the average occupancy) signifies the minimum level of occupancy for the system to deem the staff effective.

In operation 415, the first period occupancy goal is set to 90% of the average scenario occupancy. Control is passed to operation 420 and process 400 continues.

In operation 420, a requirement search is again performed with an adjustable goal. Control is passed to operation 425 and process 400 continues.

In operation 425, it is determined if the first period service level is less than the first period service level goal. If it is determined that the first period service level is less than the first period service level goal, control is passed to operation 430 and process 400 continues. If it is determined that the first period service level is not less than the first period service level goal, control is passed to operation 435 and process 400 continues.

In an embodiment, the first period service level goal is relaxed to account for a large initial backlog. Excessive staff may thus be avoided for the first period which are of little use in later periods (resulting in low occupancy).

In operation 430, the first period service level goal is set to zero. For example, the service level may be set to zero in order to increase staff utilization or occupancy. In an embodiment, where there is a lot of backlog to be cleared at the beginning, this guards against excessive staffing. While excessive staffing may be useful at the beginning of a planning scenario, excessive staff are of little use as the scenario progresses in time. Control is passed to operation 435 and process 400 continues.

In operation 435, dynamic backlog is determined. Multiple optimal solutions may be captured as a result. This process is further detailed below in FIG. 6. Control is passed to operation 440 and process 400 continues.

In operation 440, the service level is examined. If any period's service level is less than the goal, then the goal is set to the service level for that period to account for any periods where the service level is not achieved. Control is passed to operation 445 and process 400 continues.

In operation 445, the weekly staff is automatically decreased to ensure goal achievement for the first time interval. For example, staff may be decreased in certain periods without affecting service level goals of any of the time periods after requirement search and dynamic backlog control have been performed. For example, using the week as a time period, the week's staff may be decreased by 50% initially to examine whether the other weeks continue to achieve their goals. If not, the change amount is decreased to 50% of the original and staff is increased. If the scenario continues to achieve the goal, then staff may be further decreased. Using bisection on change amounts and only changing that week's staff ensures that all of the other weeks continue to achieve their goals. Control is passed to operation 450 and process 400 continues.

In operation 450, the weekly staff is automatically decreased to ensure goal achievement for the last time interval and the process ends.

FIG. 5 is a flowchart illustrating an embodiment of a process for determining an adjustable goal. This process may occur in operation 405 of the process 400. The process may be used to determine the staffing requirement given a service goal for all of the time periods or for selected time periods. In an embodiment, the process may be used where service level goals are adjustable or un-adjustable. The un-adjustable setting may be used to test a particular backlog setting which may or may not be feasible. In this example, for simplicity, the time period used will be a week, but it should be known that any time interval may be used. For example, for the week starting with the first week, service and occupancy level are estimated for an unlimited amount of staff. If the unlimited staff cannot achieve the service level goal or provide more than steady-state backlog, and the adjustable goal is flagged as true, then the service level goal or steady-state backlog values are automatically changed to those values achieved with the unlimited staff. Multiple iterations are performed to determine the staffing requirement for the week. Staff are varied until the service level or backlog levels are close to the target values. This process is repeated for the remaining weeks of the planning scenario.

In operation 505, the period is set to the starting week. Control is passed to operation 510 and process 500 continues.

In operation 510, it is determined whether or not the period occurs after the last time interval. If it is determined that the period occurs after the last time interval, control is passed to operation 515 and the process ends. If it is determined that the period does not occur after the last time interval, control is passed to operation 520 and process 500 continues.

In operation 520, an e-mail determination is made. For example, the e-mails handled and the backlog are used in the staffing requirement generation process to determine service level. The results of the e-mail determination may include the number of e-mails handled and the backlog in buckets. Each bucket may refer to a time period range in which a set of e-mails waited before being completed (e.g., 1-4 hours, 5-8 hours, etc.). In an embodiment, staffing, volume, and average handle time distribution are used for the period. Using periodic volume data and applying periodic distribution, the number of e-mails handled are simulated for all of the days. E-mails handled and backlog data are recorded at bucket level to identify how long an e-mail waited in the system and how old the backlog is. This data may also be used by the system to estimate service level, occupancy, etc. Control is passed to operation 525 and process 500 continues.

In operation 525, the daily staff distribution is adjusted based on actual daily staff values. In an embodiment, this may be done by multiplying the daily staff values to the distribution, resulting in the staffing hours for every hour of the day. Control is passed to operation 530 and process 500 continues.

In operation 530, the e-mail determination is performed for unlimited staff for the period. Control is passed to operation 535 and process 500 continues.

In operation 535, service level and occupancy are determined. For example, the total number of e-mails completed within the service level threshold is determined. This sum is then divided by the total number of e-mails completed to determine the service level. A summation is determined of the e-mails handled and the average handle time for every period. The division of this sum by the total staff results in the occupancy value. Control is passed to operation 540 and process 500 continues.

In operation 540, it is determined whether or not the goal is adjustable. If it is determined that the goal is adjustable, control is passed to operation 545 and the process 500 continues. If it is determined that the goal is not adjustable, control is passed to operation 550 and process 500 continues.

For example, the service level goal may be made adjustable to ensure that an impossible or unachievable service level goal may be adjusted by the system to ensure achievable goals. During backlog control determination, the goal may not be adjustable in order to prevent a changing backlog from changing the service goals.

In operation 545, the goal is set to less than or equal to the maximum achievable service level and the steady state backlog is set to greater or equal to the minimum achievable backlog. For example, this may be to ensure that the service goal as well as the backlog control levels are achievable. Control is pass to operation 550 and process 500 continues.

In operation 550, it is determined whether or not a solution is returned. If it is determined that a solution has been returned, control is passed to operation 560 and process 500 continues. If it is determined that a solution has not been returned, control is passed to operation 555 and process 500 continues.

In operation 555, a periodic email search is performed. For example, at the weekly level, the search procedure may be performed to update the change amount (the marginal staff add/reduce at each iteration), search direction, and service level calculation. The change may be performed incrementally or decrementally. Period staff may begin with a steady-state-staff. The steady-state-staff may be equivalent to the volume handled if the staff and volume are uniformly distributed. In order to find the optimal staffing solution for the period that meets the service performance goal/criteria, the number of staff need to be automatically increased or decreased. In an embodiment, the step size from the steady-state-staff may begin very small and double until the staff range that encloses the optimal solution is found. The optimal solution may be determined more accurately using a bisection algorithm.

The requirement amount of staff may be defined as the sum of the required amount determined up to a point and the change amount (with appropriate direction). The daily staff or volume distribution may be applied (depending on staff or volume search on the staff requirement number) and the e-mail determination procedure performend with service level, occupancy determination, and direction search. If the week search has not changed the direction, the change amount may continue to be doubled.

In an embodiment, the change amount may be very small, such as a maximum of 1 person or 1% of the currently required staff. The change amount may be automatically doubled and the change direction recalculated until the direction of the staff change is reversed. Once the direction is reversed, the bisection algorithm is applied, which keeps halving the change amount. After every change in the weekly staff, the service level, backlog, and occupancy of the week are determined. If the occupancy is low, the staff is decreased. If the service level is low or the backlog is high, the staff is increased. When the change of staff becomes the smallest possible change amount for consideration, the search is completed. For searching volume requirements, the direction of change of e-mail volume may be the opposite of the change of staff. Control is passed back to operation 550 and process 500 continues.

In operation 560, the period is incremented. In an embodiment, the period may be incremented by 1. Control is passed back to operation 510 and process 500 continues.

FIG. 6 is a flowchart illustrating an embodiment of a process 600 for evaluating dynamic backlog control as mentioned in operation 435 of process 400 above. In process 600, the optimal percentage backlog is identified which should pass from one period to another. A high staff consistency and service level goals should be achieved across all of the time periods of the planning scenarios. A number of backlog points are evaluated. In an embodiment, nine backlog points are evaluated. The point with the highest staff consistency and percentage service level goal achieved is selected. In an embodiment, up to two neighbors on either side of the point may be selected for further exploration. The other backlog points may be interpolated and the service level recalculated. The process may be repeated until the step size becomes negligible and consistent backlog percentage across the planning scenario is achieved, resulting in the maximum number of periods achieved and high staff consistency.

In operation 605, the average staff consistency is determined. For example, the ratio of staff/steady-state-staff is averaged across all of the periods. Control is passed to operation 610 and process 600 continues.

In operation 610, the backlog factor and the staff consistency are set. For example, the backlog factor may be set to 1+3*i. This multiplier will multiply on the minimum backlog control factor, which may lie around 0.125. The backlog factor may range from 0.125 to 3. The staff consistency [i] may be equal to 0 where i-0, 1 . . . 8. Control is passed to operation 615 and process 600 continues.

In operation 615, it is determined whether or not the change amount is larger than a very small amount. If it is determined that the change amount is larger than a very small amount, control is passed to operation 620 and process 600 continues. If it is determined that the change amount is not larger than a very small amount, control is passed to operation 630 and process 600 continues.

In operation 620, the backlog factor evaluation is performed. In an embodiment, the evaluation may be performed for i=1 to 8. Staff consistency and service level goal achievement are evaluated for the individual backlog factor and used by the dynamic backlog control algorithm. The backlog factor is multiplied with the initial backlog level and the unadjusted requirement search is performed. In an embodiment, the aim is not to change the service level goals. The periodic goals hit percentage is determined where the weekly goals hit percentage is calculated. If at any week the service level is below the target SLA, the whole percentage becomes zero. When the service level is above the target, different ratios may be returned. For example, if the weekly goal is within 10%*(100%−SL goal), the gap between the service level and 100% with respect to the service level goal and 100% are weighted. When weekly goals are outside of the range, the distance is considered significant and the ratio is set to 2/3 on those weeks.

The staff consistency and achievement of goals is determined and the appropriate combination for evaluation is determined. For example, any inconsistency due to staff/steady-state-staff of a period exceeding the average staff/steady-state-staff is accounted for. These periods will need more staff ratio than average. Staffing difficulty may also be provided. Any fluctuations from one period to the next are factored in and the average of these inconsistences are determined using the following:

Inconsistency+=Max(0,period staff/steady state staff−average scenario(period staff/steady state staff))

and

Inconsistency+=Abs(period staff/steady state staff−next period staff/steady state staff).

Finally, after all periods have been accounted for, the square of the average is multiplied with 33.33 to achieve a similar scale with hitting SL goal for later addition. Control is passed to operation 625 and process 600 continues.

In operation 625, the points for exploration are updated. For example, the 9 points from the existing iteration are used to create further points by interpolation based the best point identified in the iteration. The initial set of 9 points may be numbered 0, 1, . . . , 8 and have a significant range of backlog expected to contain the optimal backlog percentage at those points or in between. The points are evaluated based on staff consistency and achieving the goal. After evaluating the 9 points and selecting a threshold of, for example, no more than 5 points, the process continues for the next iteration and the remaining points are interpolated. This procedure is repeated until the change amount is negligible.

In an embodiment, if the best point is between points 2 and 6, then for the next iteration, the best point is used and the two neighbors as point 0, 2, 4, 6, and 8 and the other points are interpolated with regards to backlog. Service level is then determined.

In another embodiment, if the best point is point 7, point 7 becomes point 4 in the next iteration and point 8 remains as point 4, Point 2 and point 0 remain 1 and 2 below the neighbor of the best point.

In another embodiment, if the best point is point 8, point 7 becomes point 4 and point 6 becomes point 0, while the other points are interpolated.

Control is passed back to operation 615 and process 600 continues.

In operation 630, the steady state backlog is applied. For example, the steady state backlog may equal the product of the final selected factor and the initial backlog level. Control is passed to operation 635 and process 600 continues.

In operation 635, the requirement search is performed as un-adjustable and the process 600 ends.

The embodiments described herein may be applied in many ways. For example, an embodiment may be used for long-term, strategic staff planning for deferred work such as e-mail, casework/back-office work, fax and voicemail work. In another example, an embodiment may be used for optimizing deferred work routing systems in a multi-media contact center environment. Individual agent backlog levels can be dynamically determined so that the next work item is sent to the agent who has the least workload and backlog at the moment. In terms of agent's occupancy, the next email would be sent to an agent who has been least occupied throughout the day.

In another example, an embodiment may be used to identify outsourcing to achieve e-mail/casework service level targets.

In another example, an embodiment may be used in a multi-media/multi-skill environment to help determine how to optimally allocate staff between handling deferred work contact types vs immediate work contact types. For example, in busy periods, more staff may be allocated to handle phone/chat contact types if more staff are needed in order to achieve respective service goals. Optimization of staff re-allocation is performed from e-mail/casework to phone/chat and how many staff should be re-allocated.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1. A method for generating staffing requirements, accounting for deferred work, in a contact center environment planning system, wherein the contact center environment planning system comprises a network configuration optimization system, the method comprising the steps of:
a. performing, by the network configuration optimization system, an initial setup of parameters for at least one period of a planning scenario;
b. invoking, by the network configuration optimization system, a search to determine an optimum number of staff for the at least one period of a planning scenario; and
c. running, by the network configuration optimization system, additional planning scenarios at remaining periods of a planning scenario.

2. The method of claim 1, wherein the performing an initial setup further comprises the steps of:
a. establishing a backlog control factor, wherein the backlog control factor comprises a target ratio of backlog divided by a steady-state volume;
b. validating the parameters of the initial set up;
c. determining a steady-state staff, wherein the steady-state staff comprises an average staff uniformly distributed over the period to handle an average volume uniformly distributed over the period; and
d. determining a minimum backlog control factor from the steady-state staff, wherein the minimum backlog control comprises a minimum amount of backlog passed from one period to an other period to avoid unoccupied staff.

3. The method of claim 1, wherein the parameters comprise at least one of: deferred work volume, average handle time, target performance metric, initial backlog, initial staff, and input distributions.

4. The method of claim 1, wherein the at least one period of a planning scenario comprises a time interval.

5. The method of claim 4, wherein the time interval comprises at least one of: day, week, month, and year.

6. The method of claim 1, wherein invoking a search further comprises the steps of:
a. performing a requirement search for goals, wherein said goals are adjustable, to determine a staffing requirement given a service goal for a period;
b. adjusting the requirement search to adjust a service level goal if it the goals do not meet a threshold;
c. performing dynamic backlog control, wherein the dynamic backlog control identifies optimal backlog to be passed from one period to an other period; and
d. optimizing results of the dynamic backlog control to reduce staff in selected periods without affecting other periods.

7. The method of claim 6, wherein the requirement search further comprises:
a. determining deferred work handled and deferred work not handled, wherein the deferred work not handled are assigned to a time period range based on a length of time for completion;
b. determining service level, using the deferred work handled, backlog, and occupancy level; and
c. using the service level, backlog, and occupancy level, determining a staffing requirement given a service goal, wherein if a solution is not found, performing a periodic deferred work search.

8. The method of claim 7, wherein the periodic deferred work search comprises incrementally adjusting steady-state staff and determining a staff range of an optimal solution.

9. The method of claim 8, wherein the optimal solution is determined by applying a bisection algorithm to the staff range.

10. The method of claim 6, wherein the dynamic backlog control comprises the steps of:
a. determining an average staff consistency;
b. using the average staff consistency to determine a backlog factor;
c. evaluating the backlog factor, wherein if the backlog factor does not meet a threshold, selecting a number of points for exploration and re-evaluating the backlog factor until the threshold is met;
d. performing a requirement search for goals, wherein the goals are not adjustable.

11. The method of claim 10, wherein the dynamic backlog control comprises a number backlog points.

12. The method of claim 11, wherein the number of backlog points is nine.

13. The method of claim 7, wherein the deferred work comprises one or more of: e-mail, casework, fax, and voicemail.

14. A method for generating staffing requirements, accounting for deferred work, in a contact center environment planning system, wherein the contact center environment planning system comprises a network configuration optimization system, the method comprising the steps of:
a. performing, by the network configuration optimization system, an initial setup of parameters at a selected set of periods of a planning scenario, wherein the selected set of periods are not concurrent;
b. invoking, by the network configuration optimization system, a search to determine an optimum number of staff for the selected set of periods of a planning scenario; and
c. running, by the network configuration optimization system, additional planning scenarios at other periods of a planning scenario.

15. The method of claim 14, wherein the performing an initial setup further comprises the steps of:
a. establishing a backlog control factor, wherein the backlog control factor comprises a target ratio of backlog divided by a steady-state volume;
b. validating the parameters of the initial set up;
c. determining a steady-state staff, wherein the steady-state staff comprises an average staff uniformly distributed over the period to handle an average volume uniformly distributed over the period; and
d. determining a minimum backlog control factor from the steady-state staff, wherein the minimum backlog control comprises a minimum amount of backlog passed from one period to an other period to avoid unoccupied staff.

16. The method of claim 14, wherein the parameters comprise at least one of: deferred work volume, average handle time, target performance metric, initial backlog, initial staff, and input distributions.

17. The method of claim 14, wherein the period of a planning scenario comprises a time interval.

18. The method of claim 17, wherein the time interval comprises at least one of: day, week, month, and year.

19. The method of claim 14, wherein invoking a search further comprises the steps of:
a. performing a requirement search for goals, wherein said goals are adjustable, to determine a staffing requirement given a service goal for a period;
b. adjusting the requirement search to adjust a service level goal if it the goals do not meet a threshold;
c. performing dynamic backlog control, wherein the dynamic backlog control identifies optimal backlog to be passed from one period to an other period; and
d. optimizing results of the dynamic backlog control to reduce staff selected in periods without affecting other periods.

20. The method of claim 19, wherein the requirement search further comprises:
a. determining deferred work handled and deferred work not handled, wherein the deferred work not handled are assigned to a time period range based on a length of time for completion;
b. determining service level, using the deferred work handled, backlog and occupancy level; and
c. using the service level, backlog and occupancy level, determining a staffing requirement given a service goal, wherein if a solution is not found, performing a periodic deferred work search.

21. The method of claim 20, wherein the periodic deferred work search comprises incrementally adjusting steady-state staff, determining a staff range of an optimal solution.

22. The method of claim 21, wherein the optimal solution is determined by applying a bisection algorithm to the staff range.

23. The method of claim 19, wherein the dynamic backlog control comprises the steps of:
a. determining an average staff consistency,
b. using the average staff consistency to determine a backlog factor;
c. evaluating the backlog factor, wherein if the backlog factor does not meet a threshold, selecting a number of points for exploration and re-evaluating the backlog factor until the threshold is met;
d. performing a requirement search for goals, wherein the goals are not adjustable.

24. The method of claim 23, wherein the dynamic backlog control comprises a number backlog points.

25. The method of claim 24, wherein the number of backlog points is nine.

26. The method of claim 20, wherein the deferred work comprises one or more of: e-mail, casework, fax, and voicemail.
